(19) United States
(12) Patent Application Publication
(10) Pub. No.: US 2026/0298693 A1
(43) Pub. Date: Oct. 1, 2026

(54) DIGITALLY ASSISTED MICROWAVE MULTIPHASE FLOW METER

(71) Applicants: Saudi Arabian Oil Company, Dhahran (SA); King Abdullah University of Science and Technology, Thuwal (SA)

(72) Inventors: Muhammad Akram Karimi, Thuwal (SA); Muhammad Arsalan, Dhahran (SA); Atif Shamim, Thuwal (SA); Zubair Akhter, Thuwal (SA)

(21) Appl. No.: 19/089,716

(22) Filed: Mar. 25, 2025

(51) Int. Cl. G01F 25/10; G01F 1/661; G01F 1/74

(52) U.S. Cl. CPC G01F 25/10; G01F 1/661; G01F 1/74

(57) ABSTRACT

Systems and methods include a digital twin model for multiphase flows in the oil and gas industry. A digital twin replicating non-linear and non-monotonic dielectric properties of a multiphase mixture flowing through a pipe is generated. The digital twin includes a finite element method based electromagnetic model. The digital twin is calibrated, under controlled flow conditions at elevated pressures to generate a calibrated digital twin. The calibrated digital twin is validated using the multiphase mixture with respect to water-cut (WC) and gas volume fraction (GVF) to generate a validated digital twin. Flow rates of the multiphase mixture are received from the microwave-based sensor system. A composition of the multiphase mixture flowing through the pipe is estimated by processing the flow rates using the validated digital twin. An adjustment of a setting of an industrial equipment is triggered based on the composition of the multiphase mixture.

### TECHNICAL FIELD

This disclosure relates to multiphase flows in the oil and gas industry and, more specifically, to a digital twin model of multiphase flow measurement using microwave-based sensing.

### BACKGROUND

Industry is moving towards a more sustainable measurement solution of multiphase flow without separation in a real-time fashion and using a multiphase flow meter. Some multiphase flow meters utilize ionization radiation and fall in radioactive categories, sensitive to medium density, accurately estimating density contrast of gases with respect to the liquids. The radioactive waves pose health and safety risks associated with the use of radioactive materials. The radioactive multiphase flow meters raise the possibility of unwanted exposure to radiation if the meter is damaged or mishandled. Other multiphase flow meters are based on infrared technology, which has a great potential to distinguish the hydrocarbon molecules (crude oil and gas) from the water owing to the distinct absorption characteristics in infrared spectrum. The infrared sensing principle is intrusive because it is limited to short travel distance and source-detector pair has to form a small opening in the middle of the pipe. The infrared multiphase flow meters are based on spot measurements, depending on the mixing quality.

### SUMMARY

Implementations of the present disclosure are directed to multiphase flows in the oil and gas industry. More particularly, implementations of the present disclosure are directed to a digital twin model of multiphase flow measurement using microwave-based sensing.

In some implementations, a method includes: generating a digital twin replicating non-linear and non-monotonic dielectric properties of a multiphase mixture flowing through a pipe, the digital twin including a finite element method based electromagnetic model accounting for variations in temperature and a salinity level of the multiphase mixture, the multiphase mixture including oil, water, and gas, receiving, by one or more processors from a sensor system, calibration data and validation data, calibrating, by the one or more processors, the digital twin using the calibration data to generate a calibrated digital twin with adjusted parameters for the salinity level of the multiphase mixture, validating, by the one or more processors, the calibrated digital twin, using the validation data to generate a validated digital twin, receiving, by the one or more processors from the sensor system, flow measurements of the multiphase mixture, estimating, by the one or more processors, a composition of the multiphase mixture flowing through the pipe by processing the flow measurements using the validated digital twin, and triggering, by the one or more processors, an adjustment of a setting of an industrial equipment based on the composition of the multiphase mixture.

The foregoing and other implementations can optionally include one or more of the following features, alone or in combination. In particular, implementations can include all the following features:

In a first aspect, combinable with any of the previous aspects, wherein the sensor system includes orthogonal dual frequency microwave resonators. In another aspect, combinable with any of the previous aspects, the orthogonal dual frequency microwave resonators include two-spiral interdistanced resonators responding to changes in dielectric properties of the multiphase mixture inside the pipe by corresponding changes in resonance frequencies. In another aspect, combinable with any of the previous aspects, the two-spiral resonators include a low frequency resonator and a high frequency resonator to characterize the dielectric properties at two different frequency bands. In another aspect, combinable with any of the previous aspects, the computer-implemented method further includes: training a machine learning model to recognize a pattern of changes of a conductivity of the multiphase mixture in the pipe estimated by the digital twin. In another aspect, combinable with any of the previous aspects, the industrial equipment includes a pump or a pneumatic valve controlling a flow of the multiphase mixture. In another aspect, combinable with any of the previous aspects, the flow measurements of the multiphase mixture includes a time series including at least two time points spaced at a set time interval reflecting a change in a flow of the multiphase mixture over time. In another aspect, combinable with any of the previous aspects, wherein validating, by the one or more processors, the calibrated digital twin includes determining a fraction of matching estimated to measured data-points.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Implementations described in the present disclosure, provide multiple technical advantages. For example, the multiphase flow measurement using non-invasive sensing using safe (microwave) radiation. The described technology relates to methods and systems for measuring complex multiphase flows in the oil and gas industry by using digital twin technology. Another advantage of the described technology is that the digital twin model replicates the non-linear and non-monotonic dielectric properties of the multiphase mixture with respect to water-cut and gas volume fraction. Furthermore, the described digital twin technology facilitates continuous calibration and optimization of the microwave sensor's performance, providing real-time, high-accuracy measurements in a wide range of industrial settings. Another advantage of the described technology is that the proposed digital twin-assisted microwave-based multiphase flow meter presents a promising solution for accurate and efficient multiphase flow measurement in industrial settings that facilitates optimization of industrial machine and device operations for continuation of operation of wells and optimization of hydrocarbon management within industrial plants.

The details of one or more implementations of the subject matter of the specification are set forth in the accompanying drawings and the description below. Other features, aspects, and advantages of the subject matter can become apparent from the description, the drawings, and the claims.

### DESCRIPTION OF DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A is a is a block diagram illustrating an example system for digitally assisted multiphase flow measurement that can be used to execute implementations of the present disclosure;

FIG. 1B is an example microwave multiphase flow meter installed in industrial flow loop that can be used to execute implementations of the present disclosure;

FIG. 1C is an example microwave multiphase flow meter at another step in a fabrication process that can be used to execute implementations of the present disclosure;

FIG. 1D is an example microwave multiphase flow meter at another step in a fabrication process that can be used to execute implementations of the present disclosure;

FIG. 1E is an example microwave multiphase flow meter at another step in a fabrication process that can be used to execute implementations of the present disclosure;

FIG. 1F is an example microwave multiphase flow meter at a completion step in a fabrication process that can be used to execute implementations of the present disclosure;

FIG. 1G is an example microwave multiphase flow meter installed in industrial flow loop that can be used to execute implementations of the present disclosure;

FIG. 2A illustrates an example cross-section of a digital twin representation of three phase flow definition in water continuous phase that can be used to execute implementations of the present disclosure;

FIG. 2B illustrates an example perspective representation of the three-phase flow definition in water continuous phase that can be used to execute implementations of the present disclosure;

FIG. 3A illustrates an example numerical modelling of gas volume fraction that can be used to execute implementations of the present disclosure;

FIG. 3B illustrates another example numerical modelling of gas volume fraction that can be used to execute implementations of the present disclosure;

FIG. 4A illustrates an example cross-section of a digital twin representation including dual frequency orthogonal resonators that can be used to execute implementations of the present disclosure;

FIG. 4B illustrates an example perspective of a digital twin representation including dual frequency orthogonal resonators that can be used to execute implementations of the present disclosure;

FIG. 5A illustrates an example resonance frequency for various conductivities that can be used to execute implementations of the present disclosure;

FIG. 5B illustrates an example resonance frequency for various conductivities that can be used to execute implementations of the present disclosure;

FIG. 6A illustrates an example quality factor for various conductivities that can be used to execute implementations of the present disclosure;

FIG. 6B illustrates an example quality factor for various conductivities that can be used to execute implementations of the present disclosure;

FIG. 7A illustrates example resonant frequency validation trends that can be used to execute implementations of the present disclosure;

FIG. 7B illustrates another example quality factor validation trends that can be used to execute implementations of the present disclosure;

FIG. 8 illustrates an example process that can be used to execute implementations of the present disclosure;

FIG. 9 depicts a block diagram illustrating a computing system, in accordance with some example implementations; and

FIG. 10 illustrates hydrocarbon production operations, in accordance with some example implementations.

When practical, like labels are used to refer to same or similar items in the drawings.

### DETAILED DESCRIPTION

Implementations of the present disclosure are directed to multiphase flows in the oil and gas industry. More particularly, implementations of the present disclosure are directed to a digital twin model of multiphase flow measurement using microwave-based sensing. A digital twin replicating non-linear and non-monotonic dielectric properties of a multiphase mixture flowing through a pipe is generated. The multiphase mixture includes oil, water, and gas, flow rates of the multiphase mixture are received from a microwave-based sensor system. The digital twin includes a finite element method based electromagnetic model. The digital twin is calibrated, under controlled flow conditions at elevated pressures to generate a calibrated digital twin. The calibrated digital twin is validated using the multiphase mixture with respect to water-cut (WC) and gas volume fraction (GVF) to generate a validated digital twin. Flow rates of the multiphase mixture are received from the microwave-based sensor system. A composition of the multiphase mixture flowing through the pipe is estimated by processing the flow rates using the validated digital twin. An adjustment of a setting of an industrial equipment is triggered based on the composition of the multiphase mixture.

Some microwave based multiphase flow meters have been implemented to characterize volume fractions of a complex and variable blend of oil, water, and gases, commonly referred to as multiphase mixture. The microwave based multiphase flow meters use microwave waves that can penetrate the dielectric pipe materials, to non-intrusively characterize the fluid composition. Water, being a polar molecule, has a higher dielectric constant than oil and gases, while gases have insignificant dielectric loss as compared to liquids (oil and water). Some microwave resonance-based two-phase sensors rely on the change in the resonance frequency as well as the quality factor to measure the water content in oil (0-100%). Variations in temperature and salinity levels can affect the accuracy of microwave measurements. The application of a full set of calibration look-up tables to account for variations in temperature and salinity levels is not feasible because of excessively many possible combinations of measurements throughout a large and complex industrial plant.

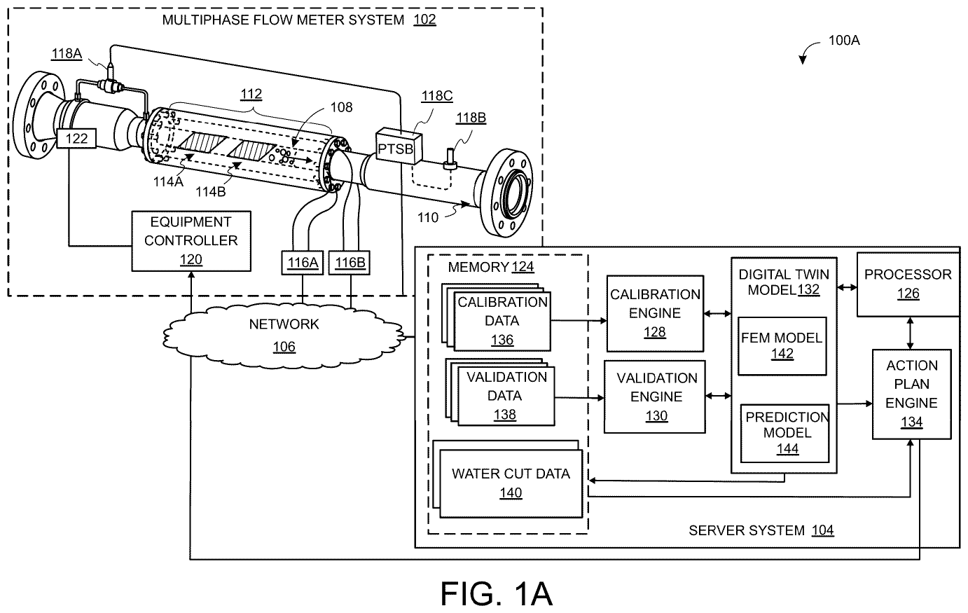

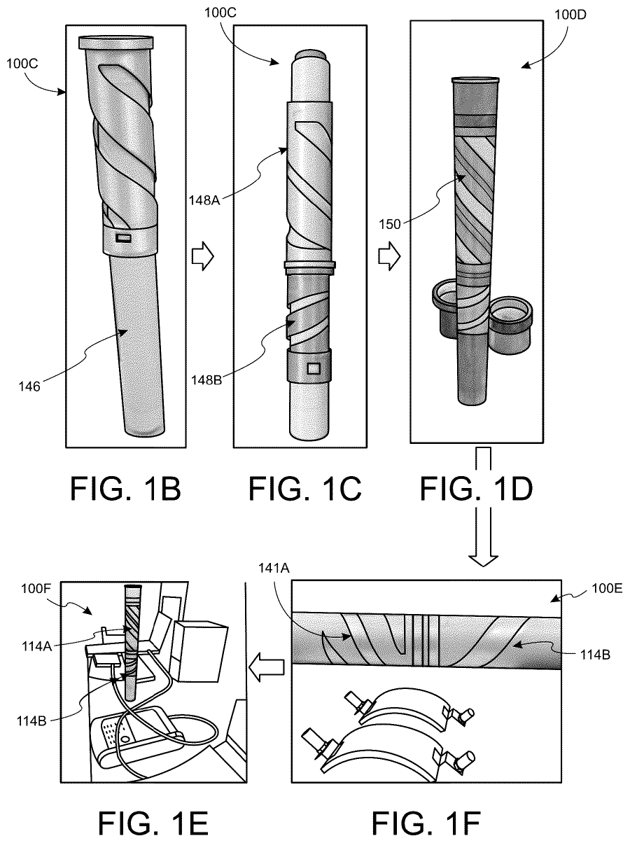

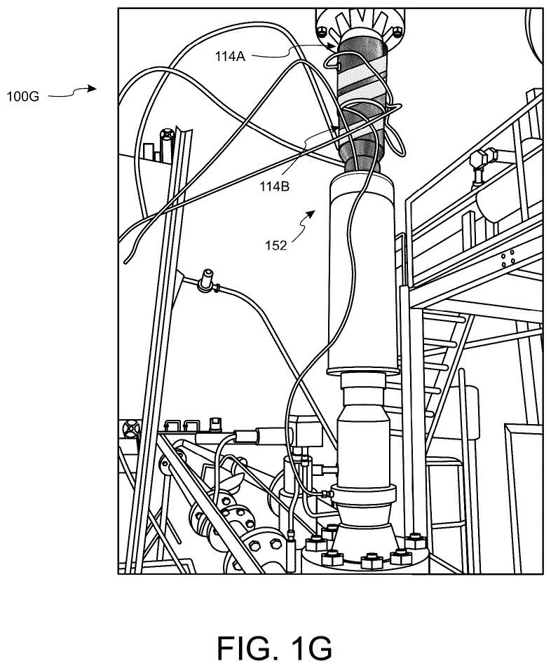

Addressing the challenges of traditional microwave-based sensing of multiphase flows in the oil and gas industry, the digital twin model of microwave-based multiphase flow measurement described in the present disclosure provides an accurate and objective fluid characterization accounting for variations in temperature and salinity levels. The described digital twin model is trained with a large set of simulation data with minimum reliance on calibration flow loop measurements. Furthermore, the described digital twin model can integrate a machine learning model that can be continuously trained to recognize response change patterns with respect to process parameters. An advantage of the implementations described in the present disclosure is that the described digital twin model replicates the non-linear and non-monotonic dielectric properties of the multiphase mixture with respect to WC and GVF. Another advantage of the described technology is that the described digital twin model continuously calibrates and optimizes the microwave sensor's measurements, providing real-time, high-accuracy characterization of a multiphase mixture flowing through a pipeline, facilitating real time adjustment of industrial settings for regulation and control of industrial plant operations. Other advantages of the digital twin model of multiphase flow measurement using microwave-based sensing techniques are described with reference to FIGS. 1A-10.

FIG. 1A is a block diagram illustrating an example system 100 for digitally assisted multiphase flow measurement that can be used to execute implementations of the present disclosure. The example system 100 includes or is communicably coupled with a multiphase flow meter system 102, a server system 104, and a network 106. Although shown separately, in some implementations, functionality of two or more systems or components of the example system 100 can be provided by multiple computing devices, a computing device connected to a computing system or a server. In some implementations, the functionality of one illustrated system, computing device, or component can be provided by multiple systems, servers, or components, respectively.

In general, the multiphase flow meter system 102 manages multiphase flow measurement of a multiphase mixture 108 flowing through an industrial pipe 110. The multiphase flow measurement of a multiphase mixture 108 can be performed using a sensor system 112. The sensor system 112 can include pipe conformable microwave resonator sensors 114A and 114B generating flow measurements processable by the server system to generate water cut data (water content in oil). The microwave resonator sensors 114A and 114B generate microwave signals and record the responses produced in interaction with the multiphase mixture 108. The multiphase measurements can be performed using vector network analyzers (“VNAs”) 116A, 116B or microwave oscillators. The process is repeated at set intervals (e.g., every 100 milliseconds or “ms”) so that the dynamics of the change in the flow of the multiphase mixture 108 can be captured. The time-based flow measurements facilitate the determination of water-fraction content in the presence of three-phases (oil, water, and gas), and further allows for the prediction of flow patterns of the fluid passing through the industrial pipe 110. In some implementations, the sensor system 112 includes a differential pressure transducer 118A, a temperature transducer 118B, and a pressure/temperature sensor box 118C that can generate additional flow measurement data indicative of the flow of the multiphase mixture 108 flowing through an industrial pipe 110.

The multiphase flow meter system 102 includes an equipment controller 120 configured to activate a flow controller 122 that controls the flow of the multiphase mixture 108 flowing through an industrial pipe 110. For example, the equipment controller 120 can trigger a modification of a setting of the flow controller 122 for adjusting pressure, flow rate, and/or volume of the multiphase mixture 108 flowing through an industrial pipe 110. The flow controller 122 can include a valve and/or a pump that can regulate any of the pressure, flow rate, and/or volume of the multiphase mixture 108 flowing through an industrial pipe 110.

The server system 104 is intended to represent various forms of servers including, but not limited to a web server, an application server, a proxy server, a network server, and/or a server pool. In general, the server system 104 manages digitally assisted multiphase flow measurement. In accordance with implementations of the present disclosure, and as noted above, the server system 104 can host a solution environment that can be a cloud environment providing software applications, systems, and services that can be consumed by customers as a service. In some implementations, the server system 104 can support digitally assisted multiphase flow measurement of different multiphase mixtures through different pipeline types, as well as services of different types that are integrated in customer integration scenarios and support execution of defined processes.

For example, the server system 104 includes a memory 124, a processor 126, a calibration engine 128, a validation engine 130, a digital twin model 132, and an action plan engine 134. The memory 124 can include any type of memory or database module and can take the form of volatile and/or non-volatile memory including, without limitation, magnetic media, optical media, random access memory (RAM), read-only memory (ROM), removable media, or any other suitable local or remote memory component. The memory 124 can store various objects or data, including caches, classes, frameworks, applications, backup data, objects, jobs, web pages, web page templates, database tables, database queries, repositories storing safety data and/or dynamic information, and any other appropriate information including any parameters, variables, algorithms, instructions, rules, constraints, or references thereto associated with the purposes of the multiphase flow meter system 102 and the server system 104, respectively. For example, the memory 124 can store raw data (e.g., data received from the multiphase flow meter system 102) and processed data (e.g., inputs and outputs of the server system 104). The raw data can include probe data, such as live monitoring data, including well rates (production rates and injection rates), water cuts, gas-oil ratios (GOR), static bottomhole pressures (BHP), and one or more zone pressures. The processed data can include calibration data 136, validation data 138, and water cut data 140. The calibration data 136 and the validation data 138 include data measured by and received from the multiphase flow meter system 102. The water cut data 140 can include data determined using the digital twin model 132. The water cut data 140 can be processed by the action plan engine 134 to generate action signals transmitted to the equipment controller 120 to modify operations of the multiphase flow meter system 102.

The processor 126 can include a central processing unit, an application particular integrated circuit, a field-programmable gate array, or another suitable component. Generally, the processor 126 executes instructions and manipulates data for digitally assisted multiphase flow measurement. The processor 126 executes a functionality required to monitor multiphase mixture flow through different pipelines of an industrial plant for anomaly detection and remediation.

The digital twin model 132 can include a finite element method (FEM) based electromagnetic (EM) model 142 and the prediction model 144. The FEM model 142 is based on FEM numerical technique to solve complex partial differential equations by breaking down a large system into smaller parts called finite elements. The FEM model 142 is configured to model electromagnetic fields and interactions between microwave resonators 114A, 114B and a multiphase flow mixture 108 flowing through a pipeline 110. The FEM model 142 uses FEM to simulate electromagnetic phenomena based on data collected from flow loop experiments. The FEM model 142 can be developed based on data collected from flow loop experiments, performed by the multiphase flow meter system 102, which include measurements of fluid properties, flow rates, and other relevant parameters.

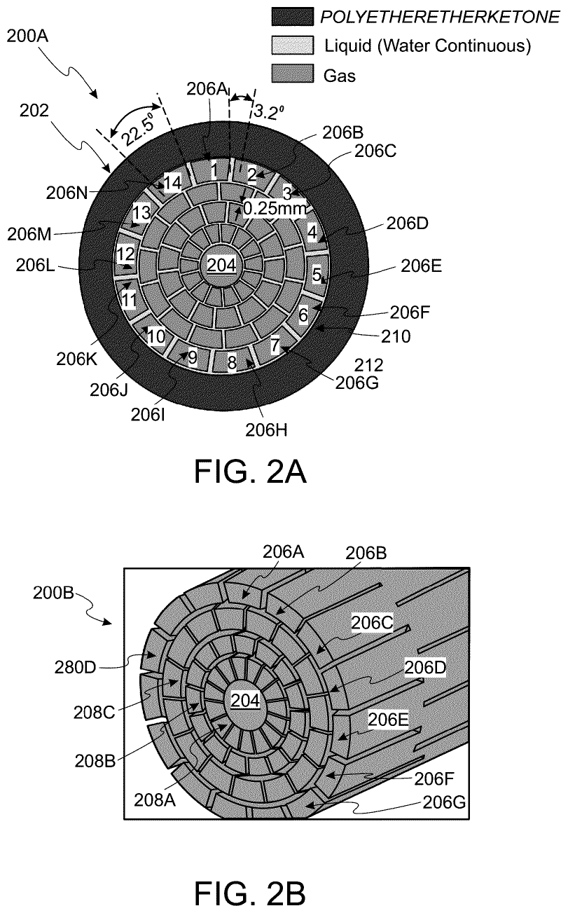

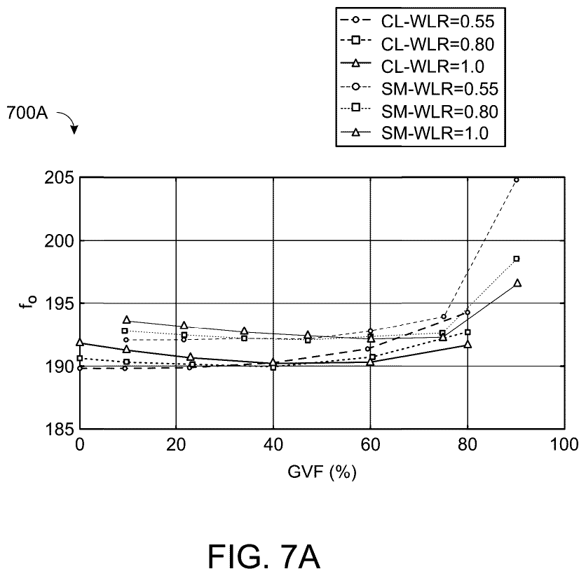

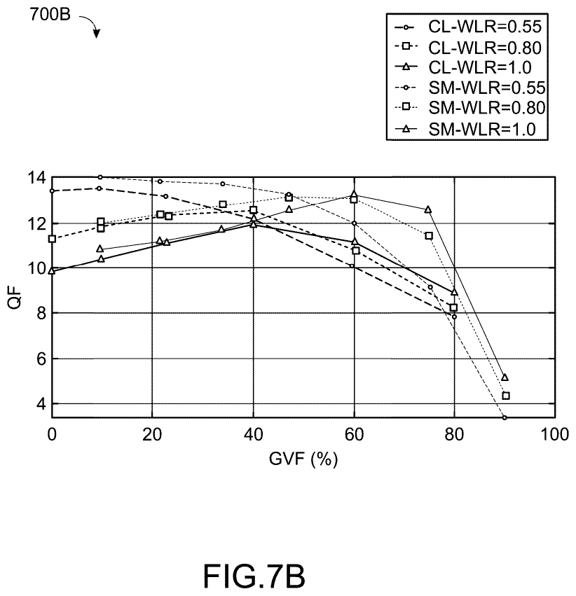

The FEM model 142 can be refined by the calibration engine 128 using calibration data 136. Calibration data 136 includes known reference measurements and system responses, used to adjust the model parameters. The calibration process ensures that the FEM model 142 accurately reflects the real-world system. The calibration engine 128 iteratively adjusts the parameters of the FEM model 142 to minimize the difference between the model predictions and the calibration data. The calibration step enhances the accuracy and reliability of the FEM model 142. The FEM model 142 can be validated by the validation engine 130 using a separate set of data known as validation data 138, as shown in FIGS. 7A and 7B. The validation engine 130 compares the model's predictions with the validation data to assess the accuracy and reliability of the FEM model 142. In response to determining that the FEM model 142 performs well on the validation data 138, the FEM model 142 can be used to process new data received from the multiphase flow meter system 102 to characterize the mixture 108. Further details about the FEM model 142 are described with reference to FIGS. 2A-4B.

The prediction model 144 can include a machine learning model trained to recognize a pattern of resonance frequency and quality factor changes with respect to multiphase mixture composition, conductivity, and temperature. For example, the prediction model 144 can include support vector machines, neural networks, random forest or a principal component analysis with machine learning model. Support vector machines are effective for classification tasks and can be used to identify flow pattern recognition. Neural networks, such as convolutional neural networks and recurrent neural networks, can capture intricate patterns in resonance frequency and quality factor trends available as time-series data. Random forest models can combine multiple decision trees to improve prediction accuracy, by handling large datasets and identifying important mixture features influencing resonance frequency patterns. The prediction model 144 can be trained on the extensive data extracted from the digital twin simulation models (e.g., validation data 138). The prediction model 144 can be trained on data that includes fluid conductivity, temperature, and resonance frequency measurements to identify the underlying patterns indicative of water cut data 140.

The digital twin model 132 can simulate the complex dielectric response of the multiphase fluid. The digital twin model 132 can accommodate the full range of multiphase fractions (WC and GVF) with accuracy across wide range of process parameters, such as salinity and temperature. The volumetric flow rates of the different components of multiphase mixtures (including oil, water, and gas) are determined in two stages. Initially, the digital twin model 132 can quantify the composition of the mixture 108, based on flow measurements received from the microwave sensors 114A, 114B including two-spiral resonators and dielectric-based sensing. The digital twin model 132 can determine the actual volumetric flow of the mixture, utilizing a venturi principle, to determine the production within a particular timeframe.

The digital twin model 132 can account for changes in conductivity, salinity, and temperature. The digital twin model 132 can process data received from multiphase meters that exploit the difference of dielectric properties of oil, water and gas to distinguish different ratios in the mixture. The digital twin model 132 can determine two dielectric properties including dielectric constant and the dielectric loss. Water being the polar molecule exhibits very high dielectric constant as compared to the hydrocarbons (oil and gas). On the other hand, liquids (esp. water) show very high dielectric loss as compared to the gas. As a first step to overcome the influence of the dielectric properties, the digital twin model 132 is configured to account for the effect of salinity and temperature on the dielectric properties of the multiphase mixture. Salinity increases the ionic concentration in the brine while increased temperatures result into easier movement of the ions. Both of these process parameters directly contribute to increase the electrical conductivity of the multiphase mixture especially that of brine. The electrical conductivity is also referred to as dielectric loss at microwave frequencies. The salinity and temperature result in minimal changes of the dielectric constant of the mixture, less significant than the change in the dielectric loss. For these reasons, the digital twin model 132 incorporates the effect of salinity and temperature in the form of the respective contribution to enhance the electrical conductivity. In order to compensate for this effect, the digital twin model 132 was calibrated and validated using data from a large set of experiments that relate the effect of salinity and temperature combination on the conductivity of the brine.

The experiments included brine with salinity ranging from 4,000 ppm to 220,000 ppm and temperature up to 60° C. The salinity (ppm) of the brine of a particular oil field varies infrequently, such that one-time calibration during the commissioning phase may be sufficient. The dielectric sensing-based methods require temperature and salinity compensation as the conductivity of the brine or saline solution is a function of the temperature and salinity. To perform the compensation, intensive temperature dependent dielectric measurement of the brine solution was performed in the laboratory and analytical equations relating the conductivity of saline concentration solution at a particular temperature were obtained and included in the digital twin model 132.

$${σ}_{eff} ( x , y ) = {A}_{00} + {A}_{10} x + {A}_{20} {x}^{2} + {A}_{11} x y + {A}_{02} {y}^{2} + {A}_{30} {x}^{3} + {A}_{21} {x}^{2} y + {A}_{12} x {y}^{2} \qquad ( 1 )$$

Parameter x represents the salinity in % [1%-25%] and y is the Temperature in ° C. [24° C.−60° C.]. The coefficients (with 95% confidence bounds RMSE=0.5922) are A₀₀=−0.5928, A₁₀=1.286, A₀₁=0.02631, A₂₀=−0.0245, A₁₁=0.01328, A₀₂=−0.000202, A₃₀=0.0001149, A₂₁=−0.0003602 and A₁₂=0.0001235. Square brackets “[ ]” represents the range of parameters for validity of the digital twin model 132.

Accounting for salinity and temperature, the digital twin model 132 can accurately determine the composition of the multiphase mixture by using the overall mixture's volumetric flow rate along with the real-time flow rates of the individual components (oil, water, and gas). The composition of the multiphase mixture defines the volumetric fractions (as percentage) of each of oil water and gas at a particular time point. The action plan engine 134 can control operation of the sensor system 112 and initiate remediation operations based on the water cut data 140. For example, the action plan engine 134 can compare the determined composition of the multiphase mixture to a target composition of the multiphase mixture that can be generated by modifying settings of the flow controller 122.

In some implementations, the network 106 can include a large computer network, such as a local area network, a wide area network, the Internet, a cellular network, a telephone network, or an appropriate combination thereof connecting any number of communication devices, mobile computing devices, fixed computing devices and server systems. Data exchanged over the network 106, is transferred using any number of network layer protocols, such as internet protocol, multiprotocol label switching, asynchronous transfer mode, Frame Relay, etc. Furthermore, in implementations where the network 106 represents a combination of multiple sub-networks, different network layer protocols are used at each of the underlying sub-networks. In some implementations, the network 106 represents one or more interconnected internetworks, such as the public Internet.

FIG. 1B is an example microwave multiphase flow meter 100B at an initial step in a fabrication process that can be used to execute implementations of the present disclosure. FIG. 1C is an example microwave multiphase flow meter 100C at another step in a fabrication process that can be used to execute implementations of the present disclosure. FIG. 1D is an example microwave multiphase flow meter 100D at another step in a fabrication process that can be used to execute implementations of the present disclosure. FIG. 1E is an example microwave multiphase flow meter 100E at another step in a fabrication process that can be used to execute implementations of the present disclosure. FIG. 1F is an example microwave multiphase flow meter 100F at a completion step in a fabrication process that can be used to execute implementations of the present disclosure.

The microwave multiphase flow meter 100B-100E includes two orthogonal resonators 114A, 114B working at different frequencies. The resonators 114A, 114B are attached to solid rod of PEEK tube 146 with a standard dimension. The solid rod of PEEK tube 146 is machined with the computer numerical control (CNC) for making a hollow tube structure. The spiral mask for each resonator can be 3D printed. The masks 148A, 148B can be placed on the PEEK tube 146 and spiral pattern of resonators 114A, 114B can be traced on the PEEK tube surface. A Polyamide (Kapton) tape 150 with silicon adhesive can be used to further mask the PEEK surface and the only exposed areas left where metal traces are going to be screen printed. The PEEK tube 146 with screen-printed resonators 114A, 114B can be placed in a high temperature chamber (~125° C.) for 24 hours for curing and high temperature rating. The outer housing including the flanges can be made up of 316 Stainless Steel (UNS31600 per ASTM A276) and rated 1000 psi pressure with a safety margin of 2×.

FIG. 1G is an example microwave multiphase flow meter 100G installed in industrial flow loop 152 that can be used to execute implementations of the present disclosure. The example microwave multiphase flow meter 100G was used for calibrating the digital twin model 132 under controlled flow conditions at elevated pressures. The industrial flow loop 152 can emulate the controlled flow of oil, water, and gases at adjustable fractional/mass flow rates to cover for a wide operation span, before the actual field deployment of the digital twin model 132. The measurements were performed on various WC. Two conductivities 4.65 S/m (~30,000 ppm) and 16.5 S/m (~130,000 ppm) were considered. The calibrated the digital twin model 132 used a dual frequency orthogonal resonators (DFOR) microwave sensor and multiple transducers (e.g., differential pressure (Foxboro IDP10) and temperature (Danfoss MBT3270) transducer for estimating the flow rates of oil, water and gas). The proposed DFOR sensor includes the two-spiral resonators 114A, 114B, which respond to the changes in dielectric compositions of three-phase mixture (e.g., oil, water, and gas) inside the pipe by corresponding changes in the respective resonance frequencies (e.g., fr₁, fr₂) and quality factors (Q₁ and Q₂). The described sensor configuration of the microwave sensor is referred to as “Dual Frequency Orthogonal Resonator” or “DFOR” configuration. The reason being that the sensor configuration uses two microwave spiral resonators that are fed orthogonal to each other and operate at two different natural resonance frequencies. The DFOR configuration exhibits enhanced dielectric sensing capabilities, facilitating a measurement of the salinity of the multiphase mixture.

FIG. 2A illustrates an example cross-section 200A of a digital twin representation of three phase flow definition in water continuous phase that can be used to execute implementations of the present disclosure. FIG. 2B illustrates an example perspective representation 200B of the three-phase flow definition in water continuous phase that can be used to execute implementations of the present disclosure. The example cross-section 200A of a digital twin representation and the example perspective representation 200B can be used to define the multiphase mixture inside a pipe, represented as a polyetheretherketone layer 202. The digital twin can numerically define the three-phase flow as including oil, water, and gas under water continuous flow regime, oil continuous flow regime or wet gas flow regime. The three-phase flow definition can facilitate a control of the dielectric properties of each phase (oil, water, and gas) independently and the dielectric response of the multiphase mixture accurately replicates its properties on the macro scale. In some implementations, a definition of the digital twin model can include a definition of the shapes of the particles of the multiphase mixture. The particles of the multiphase mixture can be geometrically parametrized to represent different relative fractions of the three phases.

The numerical definition of three phases (e.g., oil, water, and gas) of the multiphase mixture can be generated using the electromagnetic (EM) simulator Ansys® HFSS software package, as depicted in FIGS. 2A and 2B. The digital twin can be configured to consider the extreme variations in gas phase fractions, ranging from 0 to 100% water cut. Under the extreme variation conditions, two distinct situations may arise: first one gas-continuous phase (e.g., wet gas), where the volume of gas is extremely higher compared to the combined volume of oil and water with GVF>95%, and a liquid-continuous phase, where the amount of gas in the flow is relatively low in comparison to the liquid phase (water and oil) with GVF<95%.

The digital twin can be configured to include a material definition of liquid continuous region, in which the gas occupies volume fraction no more than 95%. The liquid-continuous region means that the liquid forms the continuous layer (interconnected particles), inside which the gas phase is dispersed. The digital twin can be configured to define that either of two types of liquids (oil and water) can have continuity within the liquid continuous phase itself. Based on two possible scenarios, liquid continuous phase can be further categorized into water-continuous (where oil is dispersed in continuous layer of water) and oil-continuous (where water is dispersed in continuous layer of oil). The digital twin can be configured to define a liquid continuous region in which the water forms the continuous phase, generally applicable in multiphase conditions where GVF<95% and WC>50%.

As shown in FIGS. 2A and 2B, the water-continuous phase can be modeled as a center rod 204 surrounded by isosceles trapezoidal blocks 206A-206N, having parallel concentric sides. The center rod 204 and the isosceles trapezoidal blocks 206A-206N can represent gas particles 210, surrounded (in the interstitial space) by liquid 212. In the modeling of the gas-phase, the gas particles 210 are disconnected from each other and liquid 212 forms the continuous layer from one end of the pipe to another and models the liquid as a continuous region.

The isosceles trapezoidal blocks 206A-206N can be arranged as multiple (e.g., 3 or 4) sets 208A-208D of isosceles trapezoidal blocks in one cross section of the pipe. The concentric sets 208A-208D can be mutually rotated along the radial direction so that a good mixing condition can be modeled. The isosceles trapezoidal blocks can be extruded by 20 mm length along the longitudinal direction after which the whole set can be rotated by 11.25° (half the angular size of a single trapezoidal block e.g., 22.5°). The rotation flexibility facilitates a representation of the mixed condition by the microwave sensor model not only along the radial direction but also along the longitudinal direction.

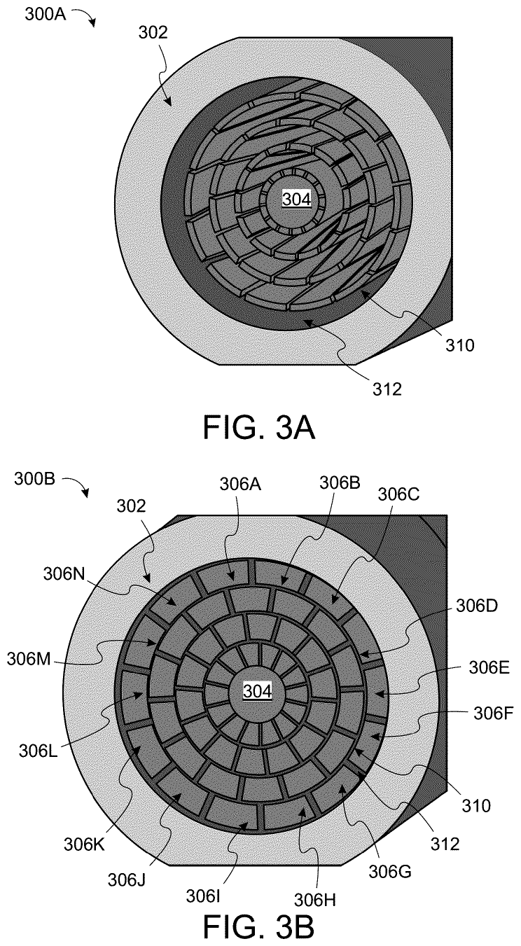

FIG. 3A illustrates an example numerical model 300A of GVF that can be used to execute implementations of the present disclosure. FIG. 3B illustrates another example numerical model 300B of GVF that can be used to execute implementations of the present disclosure. Similar to the representation of FIGS. 2A and 2B, the example numerical models 300A, 300B can represent the simulated environment as a polyetheretherketone layer 302 surrounding the multiphase mixture including a central rod 304 and isosceles trapezoidal blocks 306A-406N representing a first fluid type 310, surrounded by a second fluid type 312. The example numerical models 300A, 300B can represent the isosceles trapezoidal blocks 306A-406N having different dimensions, occupying varying volumes relative to the surrounding fluid 312 to represent different concentrations of fluids within the multiphase mixture.

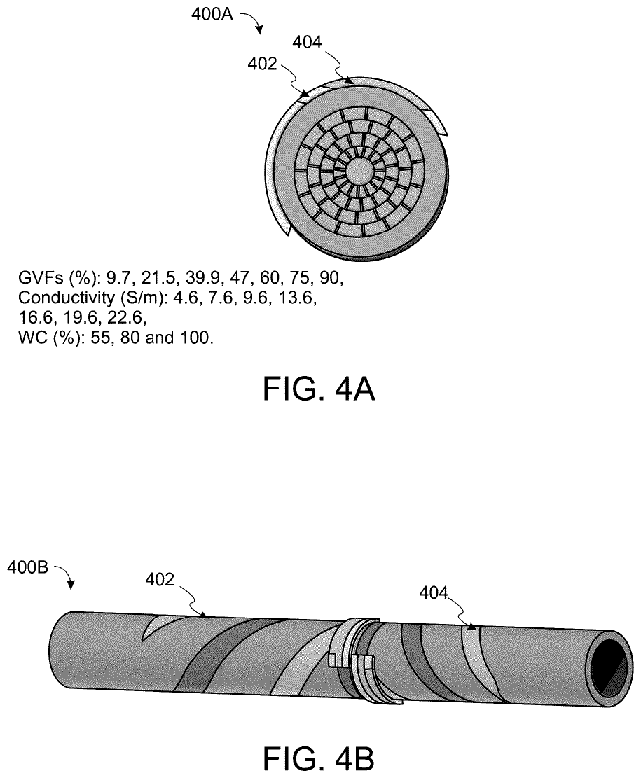

FIG. 4A illustrates an example cross-section 400A of a digital twin 402 representation including dual frequency orthogonal resonators 404 that can be used to execute implementations of the present disclosure. FIG. 4B illustrates an example perspective 400B of a digital twin 402 representation including dual frequency orthogonal resonators 404 that can be used to execute implementations of the present disclosure. The digital twin 402 can model the 3-phases of the multiphase mixture (e.g., oil, water, and gas under water continuous scenario). The digital twin 402 can include a wide operating envelope, consisting of GVF's 9.7% to 90% (7-incremental steps) and covering conductivities from 4.6 S/m to 22.6 S/m (7-linearly distant sample) under three water cuts e.g., 55%, 80% and 100%, which can be numerically simulated with the help of the commercial three-dimensional electromagnetic simulator.

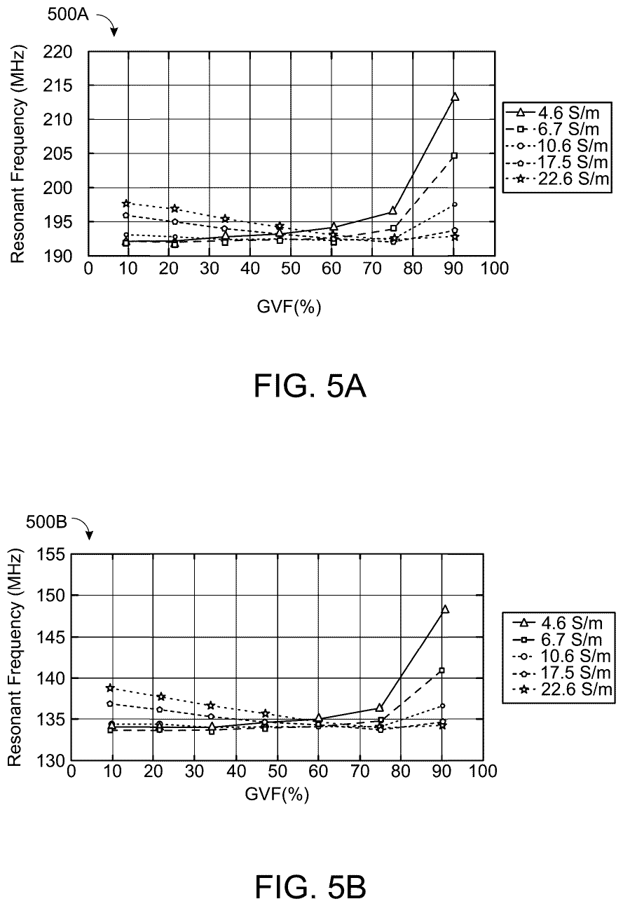

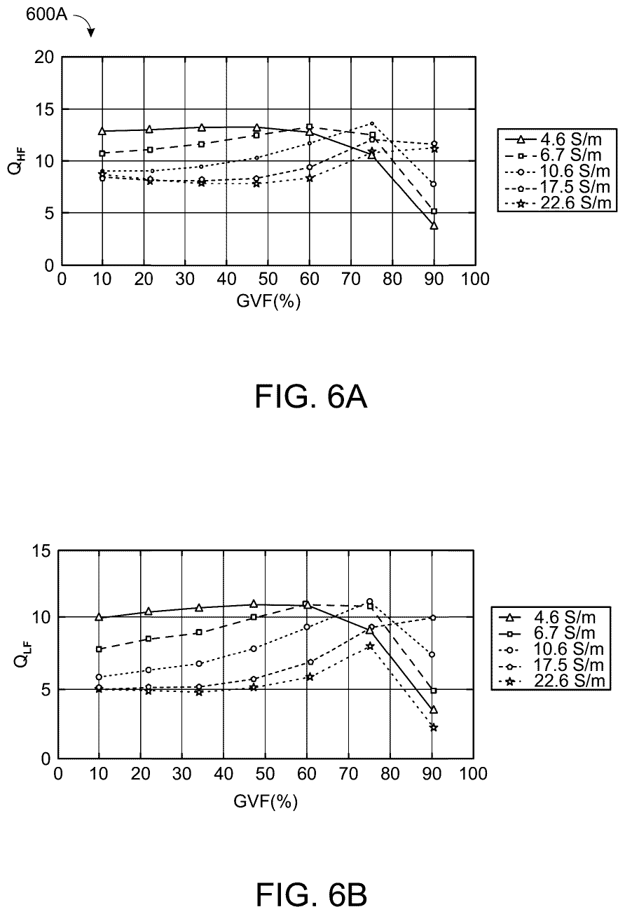

The digital twin 402 can simulate non-monotonous and non-linear changes in the behaviour in the resonance frequency for the considered conductivities and GVFs. For example, the digital twin 402 can simulate the rising trend of resonance frequencies against GVFs for lower conductivities and changing its trail and turned into decreasing trend against GVFs, as shown in FIGS. 5A and 5B. The digital twin 402 can simulate quality factor trends of both resonators plotted against GVFs for considered conductivities, as shown in FIGS. 6A and 6B. The digital twin 402 can be defined to assume that the electromagnetic fields do not uniformly interact with the multiphase mixtures having different conductivities, the conductivity of the flowing liquid being a function of inline salinity as well as temperature and can be self-regulated by inverse mapping.

FIG. 5A illustrates an example resonance frequency 500A for various conductivities that can be used to execute implementations of the present disclosure. The example resonance frequency 500A was generated by a high frequency resonator at various conductivities (from 4.6 S/m to 22.6 S/m) at WC=55% and extended GVF range e.g., 9.7%-90% water continuous phase. FIG. 5B illustrates another example resonance frequency 500B for various conductivities that can be used to execute implementations of the present disclosure. The example resonance frequency 500B was generated by a low frequency resonator at various conductivities at WC=55% and extended GVF range e.g., 9.7%-90% water continuous phase.

FIG. 6A illustrates an example quality factor 600A for various conductivities that can be used to execute implementations of the present disclosure. The example quality factor 600A was generated by a high frequency resonator at various conductivities (from 4.6 S/m to 22.6 S/m) at WC=55% and extended GVF range e.g., 9.7%-90% water continuous phase. FIG. 6B illustrates another example quality factor 600B for various conductivities that can be used to execute implementations of the present disclosure. The example quality factor 600B was generated by a low frequency resonator at various conductivities at WC=55% and extended GVF range e.g., 9.7%-90% water continuous phase. The GVF range 60-70% is very critical and highlights an inflection region (where Q-factor trends include a variation) where these curves are changing its trail.

FIG. 7A illustrates example resonant frequency validation trends 700A that can be used to execute implementations of the present disclosure. The example resonant frequency validation trends 700A include trends measured at industrial flow loop at 30° C. (shown in solid lines) and compared with the predicted response (shown in dashed lines) obtained from digital twin model for various gas volume fractions (GVF) and water-cut (WC). The results show the efficacy of the digital twin model and its operating envelope and limitations. FIG. 7A shows a significant correlation between the sensor industrial flow loop resonance frequency response and predicted values of the digital twin model for wide operating range of GVF's (9%-90%) and 3% salinity 3%.

The response at 55% WC level (shown in blue line) starts with a low fₒ value at low GVF but it takes over the resonance frequency (fₒ) values around 40% GVF, which is called the “intersection or inflection” point. The determined fₒ of each of the two sensors can be averaged to get the averaged fₒ, per system, which is mainly dependent on water content in oil flowing through the pipeline. The comparison of solid and dashed lines shown that the complex trend is accurately predicted by the digital twin model with inflection point exactly at 40% GVF. The validation trends 700B present only a small offset which can be calibrated within the calibration range from the measured flow loop data.

FIG. 7B illustrates another example quality factor validation trends 700B that can be used to execute implementations of the present disclosure. The example resonant frequency validation trends 700B include trends measured at industrial flow loop at 30° C. (shown in solid lines) and compared with the predicted response (shown in dashed lines) obtained from digital twin model for various gas volume fractions (GVF) and water-cut (WC). FIG. 7B shows that the resonator exhibits non-linear and non-monotonic change in resonant frequency against the GVF. FIG. 7B shows that just like the resonant frequency, quality factor (QF) of the microwave DMOR sensor also exhibits non-linear and non-monotonic behavior with respect to the GVF. The QF value at 55% WC and low GVF values are high which crosses over near GVF 40% just like fₒ response. The complex trend is accurately predicted by the digital twin model. The validation trends 700B indicate that the digital twin model is successful in general the same trend as is exhibited in the flow loop measurements.

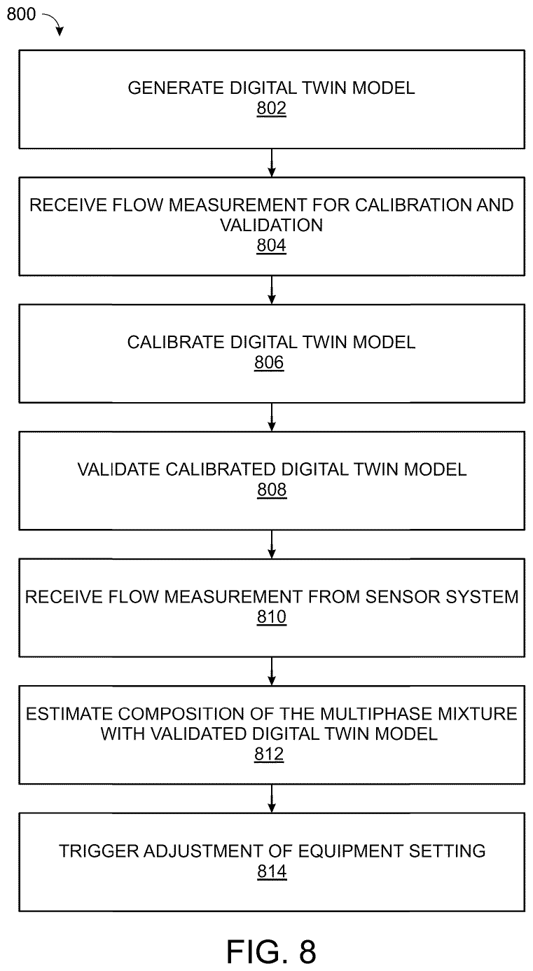

FIG. 8 depicts a flowchart illustrating an example process 800 for multiphase flow measurement using microwave-based sensing, in accordance with some example implementations. Referring to FIGS. 1A-4B, 9, and 10, the process 800 can be performed by any components of the example systems 100A-100G, 900, or 1000 or models 200A, 200B, 300A, 300B, 400A, 400B. Operations of the process 800 are described below for illustration purposes only. Operations of the process 800 can be performed by any appropriate device or system, e.g., any appropriate data processing apparatus. Operations of the process 800 can also be implemented as instructions stored on a computer readable medium which can be non-transitory. Execution of the instructions causes one or more data processing apparatus to perform operations of the process 800.

At 802, a digital twin model is generated for digital assessment of multiphase flow measurement using microwave-based sensing. The digital twin model can include a finite element method (FEM) based electromagnetic (EM) model 142 and the prediction model (e.g., FEM model 142 and the prediction model 144, described with reference to FIGS. 1A-1G). The FEM model can simulate electromagnetic fields distributed through a pipeline and a multiphase mixture flowing through the pipeline, while exposed to microwaves generated by a pair of microwave resonators. The multiphase mixture includes oil, water, and gas. The FEM model can be configured based on data collected from flow loop experiments. The prediction model can include a machine learning model trained to recognize a pattern of resonance frequency and quality factor changes with respect to multiphase mixture composition, conductivity, and temperature. The machine learning model can include a machine learning model pre-trained and fine-tuned to identify matching multiphase mixture composition characterization. In some implementations, the machine learning model can be based on machine learning techniques related to a deep neural network (DNN). A deep neural network can be referred to as a network because it can be represented by connecting different functions. For example, a model of the DNN can be represented as a graph representing how the functions are connected from an input layer, through one or more hidden layers, and finally to an output layer, and each layer can have one or more nodes. In an example, the DNN of the subject technology generates a dynamic characterization of multiphase mixtures using the training data sets as templates, with low computational requirements. The DNN model can provide quantitative value for the match between of the recorded and simulated patterns using the labeled patterns of resonance frequency and quality factor changes with respect to multiphase mixture composition, conductivity, and temperature. In one or more implementations, relationships between the received pattern data and simulated data can be determined during training of the DNN. The training step optimizes the weights and biases in the hidden and output layer such that the estimation error between the estimated mixture compositions and observed mixture compositions can be minimized. Estimation error can be root mean square deviation, or a composite of root mean square deviation, cross-correlation, or a geoscience error metric. To avoid overfitting during training, regularization of the estimation error is performed based upon the norms of weights in the hidden layers that are added to the estimation error. An optimization process can include application of a stochastic gradient descent algorithm (or any other appropriate optimization algorithm), which can use one or more iterative optimization techniques and/or use a small subset of the training dataset or batch with training samples randomly selected at a time. The variances calculated based upon the horizontal and vertical semi-variograms are included in the input feature. The optimization process can optimize the weights and biases associated with the vertical and horizontal semi-variances, and other input features such that an error in the mixture composition estimates relative to the observed mixture composition can be minimized. The process of training described here not only can minimize the error in mixture composition estimates, but also can incorporate changes with respect to conductivity and temperature. Following the completion of training that can be determined by the estimation error on the validation dataset falling below a cut-off value, the testing dataset can be used to determine the performance of the trained DNN on unseen data records that were not previously used for training. Although a DNN was discussed for the purposes of explanation, it is appreciated that the machine learning model can include other trainable machine learning techniques. Further, it is appreciated that other types of neural networks can be utilized by the subject technology. For example, a convolutional neural network, regulatory feedback network, radial basis function network, recurrent neural network, modular neural network, instantaneously trained neural network, spiking neural network, regulatory feedback network, dynamic neural network, neuro-fuzzy network, compositional pattern-producing network, memory network, and/or any other appropriate type of neural network can be utilized.

At 804, flow measurement data for calibration and validation of the digital twin model is received. The flow measurement data for calibration and validation can include flow rate, pressure data, temperature data, fluid properties, and sensor data (resonance frequencies and quality factors) from sensors attached to a pipeline (e.g., a pipe forming a section of an industrial flow plant or an industrial flow loop). The calibration data includes known reference measurements and system responses, used to adjust the model parameters. The calibration data can be generated under controlled flow conditions at set (elevated) pressures. The validation data can be used to assess the accuracy and reliability of the calibrated digital twin model. The validation data can be independent of the calibration data including measurements different from the calibration data set.

At 806, the digital twin model is calibrated, using the calibration data, to generate a calibrated digital twin model. The calibration process ensures that the digital twin model accurately reflects the real-world system. The calibration engine iteratively adjusts the parameters of the digital twin model to minimize the difference between the model predictions and the calibration data. The calibration step enhances the accuracy and reliability of the digital twin model. The salinity (ppm) of the brine of a particular oil field varies infrequently, such that one-time calibration per industrial plan can be applied.

At 808, the calibrated digital twin model is validated, using the validation data, to generate a validated digital twin model. The calibrated digital twin model can be validated using the validation data. The validation includes a comparison of compares predictions of the digital twin model with the validation data to determine a fraction of matching estimated to measured data-points to assess the accuracy and reliability of the digital twin model. In response to determining that outcome of the digital twin model matches the validation data, the digital twin model can be deployed to process new data received from any multiphase flow meter system of an industrial plant to characterize a mixture flowing through a pipeline of the industrial plant.

At 810, flow measurement is received from a sensor system. The sensor system can include pipe conformable microwave resonator sensors generating flow measurements processable by the server system to generate water cut data (water content in oil). The microwave resonator sensors generate microwave signals and record the responses produced in interaction with the multiphase mixture. The microwave resonator sensors can generate measurements can be performed using vector network analyzers (“VNAs”) or microwave oscillators. The microwave resonator sensors can generate measurements as a time series including at least two time points spaced at a set time interval (e.g., every 100 milliseconds or “ms”) reflecting change in the flow of the multiphase mixture over time. The time-based flow measurements facilitate the determination of water-fraction content in the presence of three-phases (oil, water and gas), and further allows for the prediction of flow patterns of the fluid passing through the industrial pipe. In some implementations, the sensor system includes a differential pressure transducer, a temperature transducer, and a pressure/temperature sensor box that can generate additional flow measurement data indicative of the flow of the multiphase mixture flowing through an industrial pipe. The sensor system can be installed in an industrial plant, such as a hydrocarbon production or processing plant that can include one or more operating wells and pipelines facilitating the flow of the hydrocarbons from one system to another. The sensor system can be configured to activate data collection and/or transmission according to a respective schedule defining a frequency of data collection and a duration of each collection duration. The sensor system can be configured to collect data continuously (according to the respective schedule) or can have a set trigger that initiates data collection in response to detection of one or more conditions for data collection.

At 812, a composition of the multiphase mixture flowing through the pipeline is generated using the validated digital twin model. The time-based response of the two sensors is analyzed to estimate the water-cut of the fluid passing through the pipe section. The time-based flow measurements of two interspaced microwave resonator placed with a set interdistance can be correlated. A maximum correlation value relates to the delay between the responses of two microwave resonators. The known distance between the resonators can be divided by the time delay to determine the flow rate of the fluid, used to composition of the multiphase mixture. The composition of the multiphase mixture defines the volumetric fractions (as percentage) of each of oil water and gas at a particular time point.

At 814, an automatic adjustment of an equipment setting is automatically triggered based on the determined composition of the multiphase mixture. The adjustment of an equipment setting can include a control operation of the equipment to regulate a flow of the multiphase mixture. For example, the determined composition of the multiphase mixture can be compared to a target composition of the multiphase mixture and the comparison can be used to modify settings of the flow controller. For example, the adjustment of an equipment setting can include a modification of system component operations for adjusting pressure, temperature, and/or volume, for example by valve and/or pump control. The adjustment of an equipment setting can be transmitted to be displayed by a graphical user interface.

The example process 800 allows the development and testing of the DT-assisted sensor using dual frequency orthogonal resonators (DFOR) for 3-phase metering of multiphase flow. The example process 800 can be scheduled and automated, being initiated with digital twin development for continuous multiphase flow analysis. The example process 800 provides accurate and consistent assessment results, by accounting for various temperatures and salinity levels by incorporation of an empirical relationship of salinity/temperature with conductivity, advantageously facilitating an accurate prediction the non-linear and non-monotonic dielectric response of the microwave sensor. The example process 800 helps to optimize the dielectric sensor design even without needing any expensive flow loop trial but it also reduces the complexity of the flow loop test matrix for the calibration purposes, with great potential for industrial applications. The data generated during the example process 800 is displayed on a user-friendly interface including various dashboards and reports, enabling a comprehensive mixture composition analysis. The data generated during the example process 800 can automatically update equipment settings for multiphase fluid flow management.

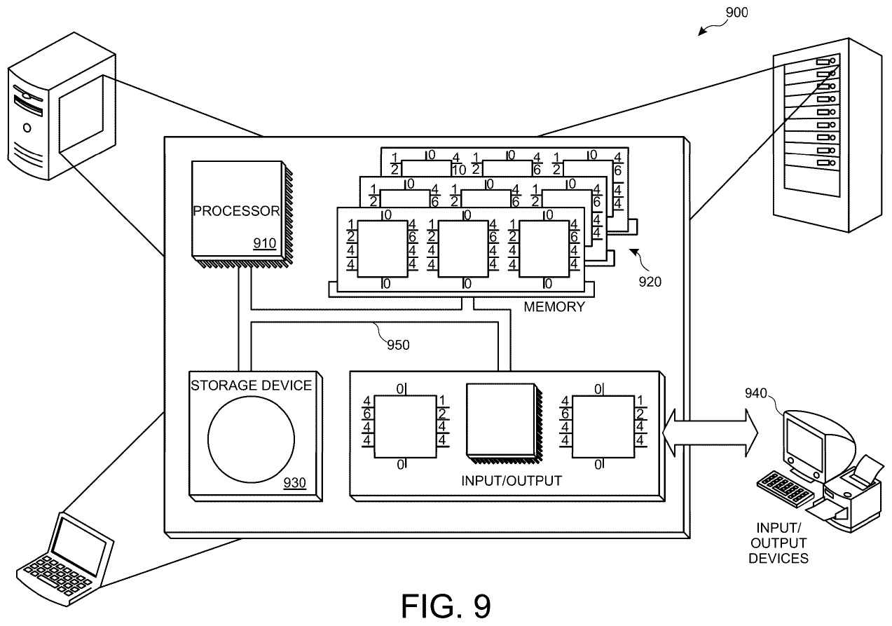

FIG. 9 depicts a block diagram illustrating a computing system 900, in accordance with some example implementations. Referring to FIG. 1A, the computing system 900 can be used to implement the computing device 102 and/or any other components of the example system 100.

As shown in FIG. 9, the computing system 900 can include a processor 910, a memory 920, a storage device 930, and input/output devices 940. The processor 910, the memory 920, the storage device 930, and the input/output devices 940 can be interconnected using a system bus 950. The processor 910 is capable of processing instructions for execution within the computing system 900. Such executed instructions can implement one or more components of, for example, the example system 100. In some implementations of the current subject matter, the processor 910 can be a single-threaded processor. Alternately, the processor 910 can be a multi-threaded processor. The processor 910 is capable of processing instructions stored in the memory 920 and/or on the storage device 930 to display graphical information for a user interface provided using the input/output device 940.

The memory 920 is a computer readable medium such as volatile or non-volatile that stores information within the computing system 900. The memory 920 can store data structures representing configuration object databases, for example. The storage device 930 is capable of providing persistent storage for the computing system 900. The storage device 930 can be a floppy disk device, a hard disk device, an optical disk device, or a tape device, or other suitable persistent storage means. The input/output device 940 provides input/output operations for the computing system 900. In some implementations of the current subject matter, the input/output device 940 includes a keyboard and/or pointing device. In various implementations, the input/output device 940 includes a display unit for displaying graphical user interfaces.

According to some implementations of the current subject matter, the input/output device 940 can provide input/output operations for a network device. For example, the input/output device 940 can include Ethernet ports or other networking ports to communicate with one or more wired and/or wireless networks (e.g., a local area network (LAN), a wide area network (WAN), the Internet).

In some implementations of the current subject matter, the computing system 900 can be used to execute various interactive computer software applications that can be used for organization, analysis and/or storage of data in various (e.g., tabular) format (e.g., Microsoft Excel®, and/or any other type of software). Alternatively, the computing system 900 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 940. The user interface can be generated and presented to a user by the computing system 900 (e.g., on a computer screen monitor).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

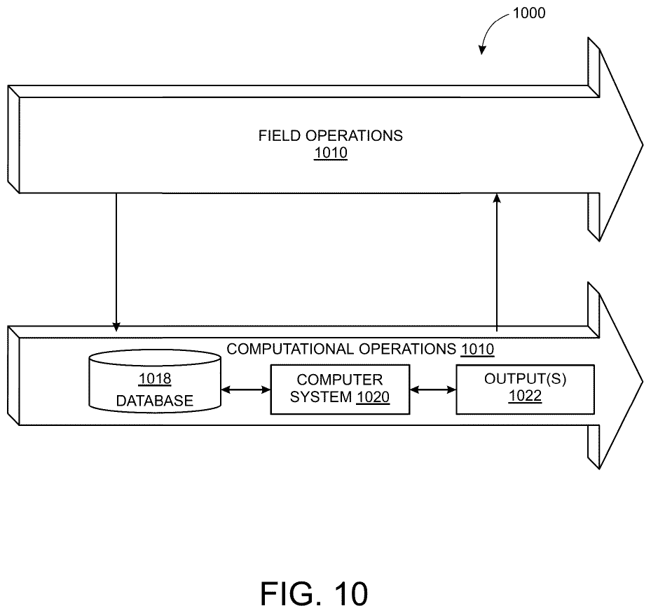

FIG. 10 illustrates hydrocarbon production operations 1000 that include both one or more field operations 1010 and one or more computational operations 1012, which exchange information and control exploration for the production of hydrocarbons. In some implementations, outputs of techniques of the present disclosure can be performed before, during, or in combination with the hydrocarbon production operations 1000, specifically, for example, either as field operations 1010 or computational operations 1012, or both.

Examples of field operations 1010 include forming/drilling a wellbore, hydraulic fracturing, producing through the wellbore, injecting fluids (such as water) through the wellbore, to name a few. In some implementations, methods of the present disclosure can trigger or control the field operations 1010. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1010 and responsively triggering the field operations 1010 including, for example, generating plans and signals that provide feedback to and control physical components of the field operations 1010. Alternatively, or in addition, the field operations 1010 can trigger the methods of the present disclosure. For example, implementing physical components (including, for example, hardware, such as sensors) deployed in the field operations 1010 can generate plans and signals that can be provided as input or feedback (or both) to the methods of the present disclosure.

Examples of computational operations 1012 include one or more computer systems 1020 that include one or more processors and computer-readable media (e.g., non-transitory computer-readable media) operatively coupled to the one or more processors to execute computer operations to perform the methods of the present disclosure. The computational operations 1012 can be implemented using one or more databases 1018, which store data received from the field operations 1010 and/or generated internally within the computational operations 1012 (e.g., by implementing the methods of the present disclosure) or both. For example, the one or more computer systems 1020 process inputs from the field operations 1010 to assess conditions in the physical world, the outputs of which are stored in the databases 1018. For example, seismic sensors of the field operations 1010 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1012 where they are stored in the databases 1018 and analyzed by the one or more computer systems 1020.

In some implementations, one or more outputs 1022 generated by the one or more computer systems 1020 can be provided as feedback/input to the field operations 1010 (either as direct input or stored in the databases 1018). The field operations 1010 can use the feedback/input to control physical components used to perform the field operations 1010 in the real world.

For example, the computational operations 1012 can process the seismic data to generate three-dimensional (3D) maps of the subsurface formation. The computational operations 1012 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1012 to process new information about the formation and control the drilling to adjust to the observed conditions in real-time.

The one or more computer systems 1020 can update the 3D maps of the subsurface formation as information from one exploration well is received and the computational operations 1012 can adjust the location of the next exploration well based on the updated 3D maps. Similarly, the data received from production operations can be used by the computational operations 1012 to control components of the production operations. For example, production well and pipeline data can be analyzed to predict slugging in pipelines leading to a refinery and the computational operations 1012 can control machine operated valves upstream of the refinery to reduce the likelihood of plant disruptions that run the risk of taking the plant offline.

In some implementations of the computational operations 1012, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 10 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

The preceding figures and accompanying description illustrate example processes and computer implementable techniques. The environments and systems described above (or their software or other components) can contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes can take place simultaneously, concurrently, in parallel, and/or in different orders than as shown. Moreover, processes can have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising: generating a digital twin replicating non-linear and non-monotonic dielectric properties of a multiphase mixture flowing through a pipe, the digital twin comprising a finite element method based electromagnetic model accounting for variations in temperature and a salinity level of the multiphase mixture, the multiphase mixture comprising oil, water, and gas; receiving, by one or more processors from a sensor system, calibration data and validation data; calibrating, by the one or more processors, the digital twin using the calibration data to generate a calibrated digital twin with adjusted parameters for the salinity level of the multiphase mixture; validating, by the one or more processors, the calibrated digital twin, using the validation data to generate a validated digital twin; receiving, by the one or more processors from the sensor system, flow measurements of the multiphase mixture; estimating, by the one or more processors, a composition of the multiphase mixture flowing through the pipe by processing the flow measurements using the validated digital twin; and triggering, by the one or more processors, an adjustment of a setting of an industrial equipment based on the composition of the multiphase mixture.

Example 2. The computer-implemented method of the previous example, wherein the sensor system comprises orthogonal dual frequency microwave resonators.

Example 3. The computer-implemented method of any of the previous examples, wherein the orthogonal dual frequency microwave resonators comprise two-spiral interdistanced resonators responding to changes in dielectric properties of the multiphase mixture inside the pipe by corresponding changes in resonance frequencies.

Example 4. The computer-implemented method of any of the previous examples, wherein the two-spiral resonators comprise a low frequency resonator and a high frequency resonator to characterize the dielectric properties at two different frequency bands.

Example 5. The computer-implemented method of any of the previous examples, further comprising:

training a machine learning model to recognize a pattern of changes of a conductivity of the multiphase mixture in the pipe estimated by the digital twin.

Example 6. The computer-implemented method of any of the previous examples, wherein the industrial equipment comprises a pump or a pneumatic valve controlling a flow of the multiphase mixture.

Example 7. The computer-implemented method of any of the previous examples, wherein the flow measurements of the multiphase mixture comprises a time series comprising at least two time points spaced at a set time interval reflecting a change in a flow of the multiphase mixture over time.

Example 8. The computer-implemented method of any of the previous examples, wherein validating, by the one or more processors, the calibrated digital twin comprises determining a fraction of matching estimated to measured data-points.

Example 9. A computer-implemented system comprising: memory storing application programming interface (API) information; and a server performing operations comprising: generating a digital twin replicating non-linear and non-monotonic dielectric properties of a multiphase mixture flowing through a pipe, the digital twin comprising a finite element method based electromagnetic model accounting for variations in temperature and a salinity level of the multiphase mixture, the multiphase mixture comprising oil, water, and gas; receiving, by one or more processors from a sensor system, calibration data and validation data; calibrating, by the one or more processors, the digital twin using the calibration data to generate a calibrated digital twin with adjusted parameters for the salinity level of the multiphase mixture; validating, by the one or more processors, the calibrated digital twin, using the validation data to generate a validated digital twin; receiving, by the one or more processors from the sensor system, flow measurements of the multiphase mixture; estimating, by the one or more processors, a composition of the multiphase mixture flowing through the pipe by processing the flow measurements using the validated digital twin; and triggering, by the one or more processors, an adjustment of a setting of an industrial equipment based on the composition of the multiphase mixture.

Example 10. The computer-implemented system of the previous example, wherein the sensor system comprises orthogonal dual frequency microwave resonators.

Example 11. The computer-implemented system of any of the previous examples, wherein the orthogonal dual frequency microwave resonators comprise two-spiral interdistanced resonators responding to changes in dielectric properties of the multiphase mixture inside the pipe by corresponding changes in resonance frequencies.

Example 12. The computer-implemented system of any of the previous examples, wherein the two-spiral resonators comprise a low frequency resonator and a high frequency resonator to characterize the dielectric properties at two different frequency bands.

Example 13. The computer-implemented system of any of the previous examples, wherein the operations further comprise:

training a machine learning model to recognize a pattern of changes of a conductivity of the multiphase mixture in the pipe estimated by the digital twin.

Example 14. The computer-implemented system of any of the previous examples, wherein the industrial equipment comprises a pump or a pneumatic valve controlling a flow of the multiphase mixture.

Example 15. The computer-implemented system of any of the previous examples, wherein the flow measurements of the multiphase mixture comprises a time series comprising at least two time points spaced at a set time interval reflecting a change in a flow of the multiphase mixture over time.

Example 16. The computer-implemented system of any of the previous examples, wherein validating, by the one or more processors, the calibrated digital twin comprises determining a fraction of matching estimated to measured data-points.

Example 17. A non-transitory computer-readable media encoded with a computer program, the computer program comprising instructions that when executed by one or more computers cause the one or more computers to perform operations comprising: generating a digital twin replicating non-linear and non-monotonic dielectric properties of a multiphase mixture flowing through a pipe, the digital twin comprising a finite element method based electromagnetic model accounting for variations in temperature and a salinity level of the multiphase mixture, the multiphase mixture comprising oil, water, and gas; receiving, by one or more processors from a sensor system, calibration data and validation data; calibrating, by the one or more processors, the digital twin using the calibration data to generate a calibrated digital twin with adjusted parameters for the salinity level of the multiphase mixture; validating, by the one or more processors, the calibrated digital twin, using the validation data to generate a validated digital twin; receiving, by the one or more processors from the sensor system, flow measurements of the multiphase mixture; estimating, by the one or more processors, a composition of the multiphase mixture flowing through the pipe by processing the flow measurements using the validated digital twin; and triggering, by the one or more processors, an adjustment of a setting of an industrial equipment based on the composition of the multiphase mixture.

Example 18. The non-transitory computer-readable media of the previous example, wherein the sensor system comprises orthogonal dual frequency microwave resonators, wherein the orthogonal dual frequency microwave resonators comprise two-spiral interdistanced resonators responding to changes in dielectric properties of the multiphase mixture inside the pipe by corresponding changes in resonance frequencies, wherein the two-spiral resonators comprise a low frequency resonator and a high frequency resonator to characterize the dielectric properties at two different frequency bands.

Example 19. The non-transitory computer-readable media of any of the previous examples, wherein the operations further comprise: training a machine learning model to recognize a pattern of changes of a conductivity of the multiphase mixture in the pipe estimated by the digital twin.

Example 20. The non-transitory computer-readable media of any of the previous examples, wherein the industrial equipment comprises a pump or a pneumatic valve controlling a flow of the multiphase mixture.

What is claimed is:

1. A computer-implemented method comprising:
generating a digital twin replicating non-linear and non-monotonic dielectric properties of a multiphase mixture flowing through a pipe, the digital twin comprising a finite element method based electromagnetic model accounting for variations in temperature and a salinity level of the multiphase mixture, the multiphase mixture comprising oil, water, and gas;
receiving, by one or more processors from a sensor system, calibration data and validation data;
calibrating, by the one or more processors, the digital twin using the calibration data to generate a calibrated digital twin with adjusted parameters for the salinity level of the multiphase mixture;
validating, by the one or more processors, the calibrated digital twin, using the validation data to generate a validated digital twin;
receiving, by the one or more processors from the sensor system, flow measurements of the multiphase mixture;
estimating, by the one or more processors, a composition of the multiphase mixture flowing through the pipe by processing the flow measurements using the validated digital twin; and
triggering, by the one or more processors, an adjustment of a setting of an industrial equipment based on the composition of the multiphase mixture.

2. The computer-implemented method of claim 1, wherein the sensor system comprises orthogonal dual frequency microwave resonators.

3. The computer-implemented method of claim 2, wherein the orthogonal dual frequency microwave resonators comprise two-spiral interdistanced resonators responding to changes in dielectric properties of the multiphase mixture inside the pipe by corresponding changes in resonance frequencies.

4. The computer-implemented method of claim 3, wherein the two-spiral resonators comprise a low frequency resonator and a high frequency resonator to characterize the dielectric properties at two different frequency bands.

5. The computer-implemented method of claim 1, further comprising:
training a machine learning model to recognize a pattern of changes of a conductivity of the multiphase mixture in the pipe estimated by the digital twin.

6. The computer-implemented method of claim 1, wherein the industrial equipment comprises a pump or a pneumatic valve controlling a flow of the multiphase mixture.

7. The computer-implemented method of claim 1, wherein the flow measurements of the multiphase mixture comprises a time series comprising at least two time points spaced at a set time interval reflecting a change in a flow of the multiphase mixture over time.

8. The computer-implemented method of claim 1, wherein validating, by the one or more processors, the calibrated digital twin comprises determining a fraction of matching estimated to measured data-points.

9. A computer-implemented system comprising:
memory storing application programming interface (API) information; and
a server performing operations comprising:
generating a digital twin replicating non-linear and non-monotonic dielectric properties of a multiphase mixture flowing through a pipe, the digital twin comprising a finite element method based electromagnetic model accounting for variations in temperature and a salinity level of the multiphase mixture, the multiphase mixture comprising oil, water, and gas;
receiving, by one or more processors from a sensor system, calibration data and validation data;
calibrating, by the one or more processors, the digital twin using the calibration data to generate a calibrated digital twin with adjusted parameters for the salinity level of the multiphase mixture;
validating, by the one or more processors, the calibrated digital twin, using the validation data to generate a validated digital twin;
receiving, by the one or more processors from the sensor system, flow measurements of the multiphase mixture;
estimating, by the one or more processors, a composition of the multiphase mixture flowing through the pipe by processing the flow measurements using the validated digital twin; and
triggering, by the one or more processors, an adjustment of a setting of an industrial equipment based on the composition of the multiphase mixture.

10. The computer-implemented system of claim 9, wherein the sensor system comprises orthogonal dual frequency microwave resonators.

11. The computer-implemented system of claim 10, wherein the orthogonal dual frequency microwave resonators comprise two-spiral interdistanced resonators responding to changes in dielectric properties of the multiphase mixture inside the pipe by corresponding changes in resonance frequencies.

12. The computer-implemented system of claim 11, wherein the two-spiral resonators comprise a low frequency resonator and a high frequency resonator to characterize the dielectric properties at two different frequency bands.

13. The computer-implemented system of claim 9, wherein the operations further comprise: training a machine learning model to recognize a pattern of changes of a conductivity of the multiphase mixture in the pipe estimated by the digital twin.

14. The computer-implemented system of claim 9, wherein the industrial equipment comprises a pump or a pneumatic valve controlling a flow of the multiphase mixture.

15. The computer-implemented system of claim 9, wherein the flow measurements of the multiphase mixture comprises a time series comprising at least two time points spaced at a set time interval reflecting a change in a flow of the multiphase mixture over time.

16. The computer-implemented system of claim 9, wherein validating, by the one or more processors, the calibrated digital twin comprises determining a fraction of matching estimated to measured data-points.

17. A non-transitory computer-readable media encoded with a computer program, the computer program comprising instructions that when executed by one or more computers cause the one or more computers to perform operations comprising:
generating a digital twin replicating non-linear and non-monotonic dielectric properties of a multiphase mixture flowing through a pipe, the digital twin comprising a finite element method based electromagnetic model accounting for variations in temperature and a salinity level of the multiphase mixture, the multiphase mixture comprising oil, water, and gas;
receiving, by one or more processors from a sensor system, calibration data and validation data;
calibrating, by the one or more processors, the digital twin using the calibration data to generate a calibrated digital twin with adjusted parameters for the salinity level of the multiphase mixture;
validating, by the one or more processors, the calibrated digital twin, using the validation data to generate a validated digital twin;
receiving, by the one or more processors from the sensor system, flow measurements of the multiphase mixture;
estimating, by the one or more processors, a composition of the multiphase mixture flowing through the pipe by processing the flow measurements using the validated digital twin; and
triggering, by the one or more processors, an adjustment of a setting of an industrial equipment based on the composition of the multiphase mixture.

18. The non-transitory computer-readable media of claim 17, wherein the sensor system comprises orthogonal dual frequency microwave resonators, wherein the orthogonal dual frequency microwave resonators comprise two-spiral interdistanced resonators responding to changes in dielectric properties of the multiphase mixture inside the pipe by corresponding changes in resonance frequencies, wherein the two-spiral resonators comprise a low frequency resonator and a high frequency resonator to characterize the dielectric properties at two different frequency bands.

19. The non-transitory computer-readable media of claim 17, wherein the operations further comprise:
training a machine learning model to recognize a pattern of changes of a conductivity of the multiphase mixture in the pipe estimated by the digital twin.

20. The non-transitory computer-readable media of claim 17, wherein the industrial equipment comprises a pump or a pneumatic valve controlling a flow of the multiphase mixture.
